(19) United States
(12) Patent Application Publication
(10) Pub. No.: US 2016/0260032 A1
(43) Pub. Date: Sep. 8, 2016

(54) Web-Based Reservation Systems and Methods

(71) Applicant: Beauty Knock LLC, Los Angeles, CA (US)

(72) Inventors: See Chin Woon, Santa Monica (MY); Kristin Tutor Eberts, Los Angeles, CA (US)

(21) Appl. No.: 14/637,285

(22) Filed: Mar. 3, 2015

(51) Int. Cl. G06Q 10/02; G06Q 10/06

(52) U.S. Cl. CPC G06Q 10/02; G06Q 10/06311

(57) ABSTRACT

Systems and methods for optimizing web-based reservation systems involving a network of service providers and end-users are provided herein, including specific methods that improve the utilization of service providers. In a web-based software product or service that already incorporates a first method to communicate via a network and reactively facilitate transactions between registered service providers and registered users in a geographic region based on user demand and service provider availability, the additional use of a second method to improve the utilization of at least a first service provider with whom a first user transaction has already been facilitated by the said first method, wherein said second method proactively facilitates the next transaction between said first service provider and a second user.

### FIELD OF INVENTION

This invention relates to online reservation systems and methods. More specifically, the invention relates to improvements in optimizing web-based reservation systems and methods involving a network of service providers and end-users.

### BACKGROUND OF THE INVENTION

The abstract problem of a merchant service provider identifying a need for a useful service, and then providing it to the needy customer with as little delay as possible, at a competitive price, is a basic foundation of commerce. Specific permutations of this problem arise in numerous service industries, including taxi services, laundry services and beauty salons, and rudimentary solutions to these problems emerged well before the advance of computers and the internet. Included in these early solutions were primitive reservation and booking systems that service providers developed to maximize the number of interested customers to whom a service provider would be able to service over a work day.

However, these traditional solutions were based on static or sub-optimal methods, where market research was conducted to identify or verify a need for a service and the associated customer base, a useful service developed at an optimal price point, and services advertised and provided to targeted customers. The early reservation systems used to maximize the utility of a service provider's workday were also static, with the service provider or its agents (a) contacting a potential customer in the area through advertisements, offers in the mail, cold calls and door-to-door campaigns, or (b) waiting for a customer to call, or walk-in to the office. In situations involving commonly useful services (e.g., haircut, landscaping, or pet grooming) involving thousands or millions of potential customers in a serviceable region, these older reservation systems were significantly limited by the impossibility of reaching and checking availability of all potential customers and, instead, relied primarily on waiting for a customer to call and make a service appointment, either at the customer home/office, or at the service provider's offices.

The advent of computers and the internet brought significant inventive advances to solving such large-scale (and previously unsolvable) problems on a dynamic, real-time, basis. Services can now be scheduled over the internet directly from the website of the service provider, or through the website of a third party intermediary or matchmaker. Innovative on-demand web-based systems that provide a matchmaking service between customers and service providers have recently become popular. One sector of these new web-based on-demand systems offer available service providers to a customer at a customer-specified location and time. “Beauty on demand” service intermediaries such as stylebee.com, gopriv.com or gohaircut.com offer “salon-quality services, delivered anytime, anywhere,” providing customers the opportunity to get blowouts, nails, hair styling and makeup delivered to a location of their choice “with the click of an app.” See, for example, U.S. Pat. No. 7,069,228, titled “Apparatus and method for an internet based computer reservation booking system”; U.S. Pat. No. 7,610,208 titled “Booking system and method”; U.S. Pat. No. 8,271,309 titled “Method and system for providing and administering online rental vehicle reservation booking services”; and U.S. patent application Ser. No. 13/674,823 titled “Service management system and methods for facilitating on-demand services,” the teachings of which are incorporated by reference.

Another sector of novel on-demand web-based transportation systems focus on moving a customer more efficiently from one point to another. For example, Uber and Sidecar, facilitate transactions between users (passengers) and service providers (drivers) who have previously registered information with Uber (www.uber.com) and Sidecar (www.side.cr). See, for example: U.S. Pat. No. 6,356,838, titled “System and method for determining an efficient transportation route”; U.S. patent application Ser. No. 10/532,501 titled “Method, system and apparatus for providing transportation services”; U.S. patent application Ser. No. 13/672,658 titled “Determining a location related to on-demand services through use of portable computing devices”; and U.S. patent application Ser. No. 13/672,634 titled, “Providing on-demand services through use of portable computing devices”; the teachings of which are incorporated by reference.

Yet another segment of modern web-based on-demand services focus on more efficiently bringing a consumer to the service provider location. On-demand restaurant reservation systems such as OpenTable (www.opentable.com) allow registered patrons to look for restaurants in a preferred geographic area and make reservations through the internet, whether from a desktop computer or a mobile device (phone, tablet etc.). See for example: U.S. Pat. No. 8,856,117 titled “System and method of accelerating response time to inquiries regarding inventory information in a network”; and U.S. patent application Ser. No. 12/179,348 titled, “Offer based restaurant reservations”; the teachings of which are incorporated by reference.

However, these aforementioned and other currently existing web-based systems are still inefficient or contain other deficiencies. For instance, they are based on customer “pull” for the service. i.e., unless a registered Uber user asks for a car service, Uber would be unable to match it through one of its registered and available drivers. Further, since Uber takes a commission on every completed matchmaking transaction, Uber's systems are designed to maximize the number of transactions for Uber (and not the registered driver on the Uber network), and focus on providing its users (passengers) a ride from any nearby registered Uber driver with as little delay as possible. Thus, Uber is focused on maximizing value for the paying end-user (passenger), and does not attempt to maximize opportunities for its registered drivers. Uber's registered service providers (drivers) have to wait patiently for a “pull” from the Uber network, not only before they can provide a ride, but also after they have provided a ride, and before they get their next passenger.

Likewise, OpenTable maximizes revenue for its restaurant partners who pay a commission for restaurant reservations made through OpenTable. Even then, restaurant partners have to wait for an indeterminable time for a consumer to either use the OpenTable network, or contact them directly, to make a reservation. OpenTable does not attempt to maximize the consumer's preference or availability since these are generally unknown or unpredictable. Thus, in these “three-party” systems involving a matchmaker, service provider and an end-user, business relationships between two of the parties tend to dominate and define the relationship to some detriment of the third party who could be better-utilized with an improved system.

The problems highlighted above have generally not been addressed, and this is not merely because a matchmaker like Uber or OpenTable is potentially less motivated to solve it. It remains unsolved because a general technical solution is impractical, even within a specific service sector. There are countless permutations and combinations to match thousands of inhabitants (many of them potential drivers, passengers, eateries and eaters) in a large metropolitan area, and it becomes an impossible task when the needs and availability of these inhabitants vary and fluctuate at any given instant in a largely unpredictable manner based on mostly hidden personal needs and preferences.

A new on-demand web-based system that specifically addresses at least one aspect of these problems (the more efficient use of the service provider) in a way that increases efficiency, value and utility of the facilitation/reservation/transaction system for all participants (the end-user, service provider, and transaction facilitator/matchmaker) has been developed, and is the subject of the invention described herein.

### BRIEF DESCRIPTION OF THE DRAWINGS

Additional aspects, features, and advantages of the invention, as to its structure, assembly and use, will be understood and become more readily apparent to one skilled in the art when the invention is considered in light of the following description of illustrative embodiments made in conjunction with the accompanying drawings, wherein:

FIG. 1 depicts one of the problems in the prior art

FIG. 2 depicts an overview of one generalized embodiment of the invention.

FIG. 3 depicts an overview of one illustrative embodiment of the invention.

FIG. 4 depicts an overview of another illustrative embodiment of the invention.

### DETAILED DESCRIPTION OF EMBODIMENTS OF THE INVENTION

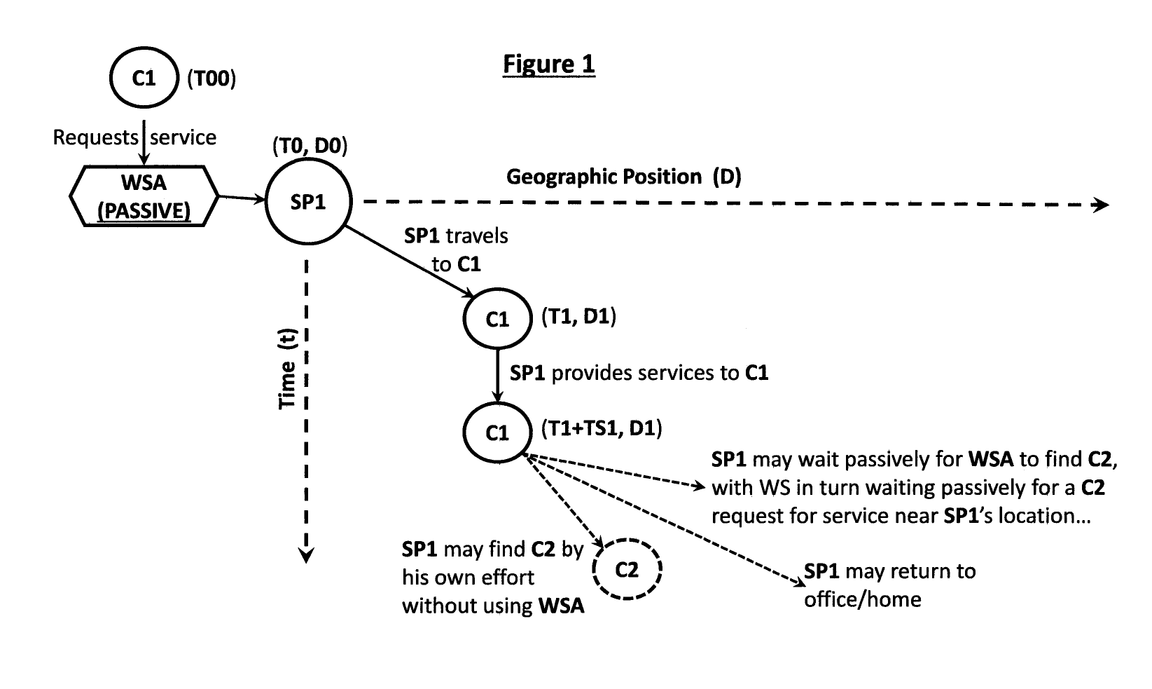

Illustrative and alternative embodiments of systems and methods for improving utilization of service providers in on-demand web-based applications are described in detail with reference to FIGS. 1-3 of this application. Terms and definitions (in bold when they first appear) are used for convenience to describe the various embodiments. However, the invention is not limited to any embodiment(s), figure(s), system(s), method(s), acronym(s) or definition(s) described herein.

Web-based applications are generally well-known and available on a wide variety of computing platforms supported by various operating systems, and are one subset of computer program products commonly known as “apps.” With the growth of mobile devices (smartphones, tablets etc.), these computer programs have become ubiquitous; “mobile apps” can be downloaded on a person's mobile devices from the “app store” and are available for use to the person on the move, in real-time.

Web-based applications described herein are computer-implemented methods or computer program (i.e., software) products, including software as a service (‘SaaS’). These are typically embodied on a computer-readable storage medium; and/or a processor, such as a processor that is configured to execute instructions stored on and/or provided by a memory coupled to the processor. The term “processor” generally refers to one or more electronic devices, circuits, and/or processing cores configured to process data, such as computer program instructions. In addition, a processor or memory component that is configured to perform a task may be implemented as a general component that is temporarily configured to perform the task at a given time, or a specific component that is manufactured to perform the task. “Memory” refers to the physical devices used to store programs (sequences of instructions) or data (e.g. program state information) on a temporary or permanent basis.

WSA refers to a web-based service application or internet portal that is designed and developed as a computing platform for facilitating the provision of service transactions between service providers and end-users/customers. “Facilitating” in this context can range from simple matchmaking (identifying and connecting customers interested in a professional service with a capable service provider willing to provide the service), to more complex systems where the WSA also has the necessary infrastructure for managing various aspects of the service, such as transaction processing (credit card information entry, secure communications network, card holder verification at a banking site, transaction processing etc.), and where WSA also completes the transaction as an intermediary, on behalf of both the end-user and service provider, collects payment from the end-user, and ensures that the service provider gets paid. WSA may also obtain a commission for the facilitation service which may be paid by the service provider and/or the end-user.

The WSA enables prospective customers to use their internet connections via landline or wireless networks, using either desktop or mobile electronic devices (personal computers, laptops, tablets, smartphones, smartwatches, etc.). The WSA is first downloaded as an app. To download the WSA (as a service “app”), the prospective customer register with the website by providing background and personal information, along with information on services required. Likewise, service providers can also download the WSA app, provide background information, along with information on the range of services that they can provide at appropriate price points, the typical length of time a specific service(s) may take, etc. The type of information that is included and registered may also vary depending on the type of professional service and the customer base.

The WSA develops and maintains a list of known (registered) and potential (unregistered) customers as part of its database, and may also include a large network of registered service providers over the broad geographic region (“GR”) in which the provider of the WSA operates. Marketing, advertising and new registration transactions between WSA, service providers and users constantly add customer and service provider information to this database.

The WSA databases may also contain sub-databases or links to other databases outside the WSA organization. For instance, a service provider may be willing to offer access to its customer databases because WSA, with its larger scale, may be more efficient in filling appointments for the service provider even with the service provider's direct customers.

The professional services offered through WSA can include transportation services (e.g., chauffeur/taxi service), beauty/cosmetology services (hair, make-up, etc.), house repair (plumbing, electrical, mechanical, handyman), baby/dog-sitting, pet grooming or automobile cleaning/detail, house-cleaning/maid services, laundry services, dating services, grocery delivery, medical services, and the like.

For convenience, the embodiments of the invention described herein are based on the example of a professional service provider (SP) who travels to a specific location requested by a customer (C) to provide services at C's location.

In one embodiment of the invention, the WSA is developed, managed and provided directly by a service provider organization (“SPO”) through the SPO's own computer systems and web servers (i.e., through the SPO's own website and apps that can be downloaded on a potential customer's desktop or mobile device), and the professional services are provided by service providers (SPs) who are generally employees or agents of the SPO.

In another embodiment of the invention, the WSA may be provided by an intermediary or matchmaker organization (“MM”). MM does not directly provide any services, but MM essentially operates as an internet broker between an end-user/customer (“C”—the one who pays for the professional service) and the third party professional service provider (also referred to as “SP” for convenience). MM usually charges a commission (usually paid by the service provider) for facilitating the provision of services to the end-user (who usually pays for the service). When the WS system is being operated by a matchmaker MM, then, in addition to registering customers, WS also registers qualified professional service providers on its network and thus has a readily available database of these service providers and, in some cases, MM may also have access to the customer databases of these service providers under appropriate business arrangements.

In one embodiment, registration information in the WSA network/database may include privacy preferences (ranging from a complete “opt-out” by a customer from any solicitation, to specific times during which a customer or service provider will accept communications, to unblocked contact at any time). The registration system may also include communication preferences for both the service provider(s) and customer(s) (e.g., Short Message Service (SMS) or multimedia message service (MMS) or email or phone or other alerts). In addition, at the discretion of the service provider or customer, the registration system may also allow the WSA selective or full access to the service provider or customer's calendar on a dynamic/synchronized basis, so that WSA can electronically check for vacancies and open space and book appointments without having to send a notice to which the service provider or customer must manually reply to via email or text.

GR refers to the geographic service region in which WSA operates; C is the typical customer found in GR who is interested, from time-to-time, in receiving a professional service; and SP is a typical professional service provider who may be willing to provide professional services to C, based on price, availability and proximity to C.

SP1, SP2, SP3, etc. each refers to a service provider who may be located anywhere in GR (including a subset of GR, such as GR1, defined further below) who is ready, willing and able to provide on-demand services to any customer located in GR1.

GR1 is a geographic region that is a subset of GR—a neighborhood—that is within reasonable proximity to a specific existing or potential customer “C1.” Proximity is generally defined either in terms of an approximate travelling time (“T”) or approximate travelling distance (“d”) from one point to another. It is determined dynamically (i.e., in real-time) by WSA based on d, road & traffic conditions, route, weather, etc., using any of the computational methods that are already known to those skilled in the art and found in products and services such as Google Maps, SigAlerts, etc., using global positioning system (GPS), cellular triangulation or similar techniques already known to those skilled in the art.

However, in one embodiment of the invention, WSA may define proximity using variables in addition to traveling distance and time. For example, the type of service provided can affect a proximity calculation or setting. If it is a hard-to-find or premium service, a customer may be willing to wait for a longer period of time, and a standard one-week reservation notice may be viable. In other situations involving commodity-type services, one customer's need may be immediate, requiring a service provider very near the area, whereas another customer may be reserving a service for a future day, and could potentially be serviced by a service provider who is farther away. Put another way, in one embodiment of the invention, the proximity may be assessed based on the customer's level of urgency for the service or even directly specified by the customer in response to a query from the WSA.

C1 here may also refers to a first customer that has requested service from WSA, and SP1 may also refer to the first professional service provider that has agreed to provide services to C1 through WS.

C2, C3, C4, etc. each refer to other potential or existing customers in GR, including GR1.

T00 refers to the actual time, based on the clock in geographic region GR, when C1 contacts WSA with a request for professional services.

T1 refers to the actual time, based on the clock in geographic region GR, when C1 desires to receive professional services at a location specified by C1 will be performed (i.e., the time when services will begin to be provided).

T0 refers to the actual time, based on the clock in geographic region GR, when SP1, who has been informed of the availability of customer C1 by WSA, accepts WSA's offer to provide services to C1.

T2A=A probabilistic estimate of the time likely to travel from C1 site to a C2 site when C2 has not yet been identified. There are many ways of doing this. In one embodiment, this time can simply be approximated as the time required to travel half the average distance between any two perimeter points of geographic region GR1 where C1 and C2 are likely to be located. In another embodiment, this can be calculated based on WSA's knowledge of other known potential customer locations in WSA's database within region GR1. For example, if most customers are in the northeastern area of GR1, then T2A can be specified as the approximate time to travel between the C1 location and the middle of the northeastern region of GR1 and, in a more complex embodiment, also based on weather, road and traffic conditions approximated at the time service provider SP1 is likely to be travelling.

T2=Estimated time to travel from C1 site to C2 site when C2 has already been identified.

TS1=Estimated time to provide services to C1 at a location specified by C1.

T2S=A probabilistic estimate of the time likely to service a next customer C2, when C2 has not been identified. This can generally be estimated based on the type of service (e.g., a haircut is 20 minutes) of, if there is more than one service offered then the average of the time taken by all the services. In a more complex embodiment, this can be calculated based on WSA's knowledge of other known potential customer locations in WSA's database within region GR1, and the average length of the services used by customers in this region in the past.

AW1=Time availability window of SP1 to provide services to a second customer C2 (and potentially other customers after that), after service to C1 has been completed

X1=Time period or duration by which C2 must respond to WS offer for services at C2 site.

AT=Average time usually required by a service provider for a specific type of service

CS1=Time required to provide a custom service to C1

D0, D1, D2 etc. refer to geographic positions that can be defined at various levels of precision by various methods such as a physical address, or global positioning system (GPS) coordinates, or through the use of triangulation techniques commonly available on electronic devices such as computers, smartphones and the like.

Prior art methods employed by travelling service providers described in the background section focus on matching a specific first customer (C1) to a specific service provider (SP1), and no longer worry about finding the next customers (C2, C3, C4.) for SP1—and finding these additional customers for SP1 is an important aspect of this invention, as will be described in more detail below.

FIG. 1 illustrates a typical problem that is common with many of the current on-demand reservation systems outlined in the “Background” section above, particularly (but not only) in situations where a professional service provider travels to a customer location to provide a requested service. These prior art systems are generally referred to as “passive” or “reactive” systems because, as explained below, they do not proactively seek to maximize opportunities to provide services from a service provider's perspective.

In FIG. 1, a first customer C1 requests a service at time TOO through an on-demand web-based application WSA. WSA is passive or “reactive” in the sense that it is not actively looking for customer C1—it is merely waiting for C1 or any other customer to contact it and request a service.

FIG. 1 assumes that a service provider SP1, located at a geographic positon D0, accepts C1's offer through intermediary WSA at time T0. SP1 arrives at C1, located at geographic position D1, at time T1, and completes the service by time T1+TS1.

Once the service to C1 is complete, SP1 then has three options to try and maximize the time SP1 uses to provide additional services during that work day:

(1) Wait passively for WSA to find C2—another customer that SP1 can service. During this time WSA is passively waiting for other customer requests and not looking to find other opportunities for SP1. Even if another customer request comes in, there is no guarantee that this new customer is even in an area serviceable by SP1. Further, even if this new customer is in an area that is serviceable by SP1 WSA may prefer to offer this customer to another service provider in its network who is better situated to service the customer.

(2) SP1 may have already scheduled another customer opportunity C2 through his own independent efforts without using WSA. But in this situation SP1 relies on his own network of customers and may not be fully leveraging the significantly larger customer database of WSA which may be significantly larger (particularly if WSA is a matchmaker service with a larger database of existing or potential customers). Further, it may be impossible or impractical for SP1 to look for the next customer while SP1 is busy providing services to C1.

(3) SP1 may return to his home/office and service customers (or wait for another alert from the WSA system at SP1's office/home).

Clearly, this is not the most efficient use of SP1's time by the passive WSA and leads to potentially wasted service revenue for SP1 and WSA. This problem arises because WSA, as an intermediary, is more concerned about maximizing its revenue opportunity by focusing on the next customer in its network that can be serviced by any proximate available service provider (not necessarily SP1). WSA's first priority is to maximize value for its paying customers—the end-users of the professional service—since WSA's broker fee is a percent of what the service provider charges the customer. Thus this situation results in a three-party WSA system aimed at maximizing transaction efficiency for two of the parties (WSA and the end-user) while the third party's (the service provider's) interest in maximizing opportunities after the first transaction is not addressed. This problem can be solved by WSA taking a more active approach after the first customer C1 has been identified and this is described next.

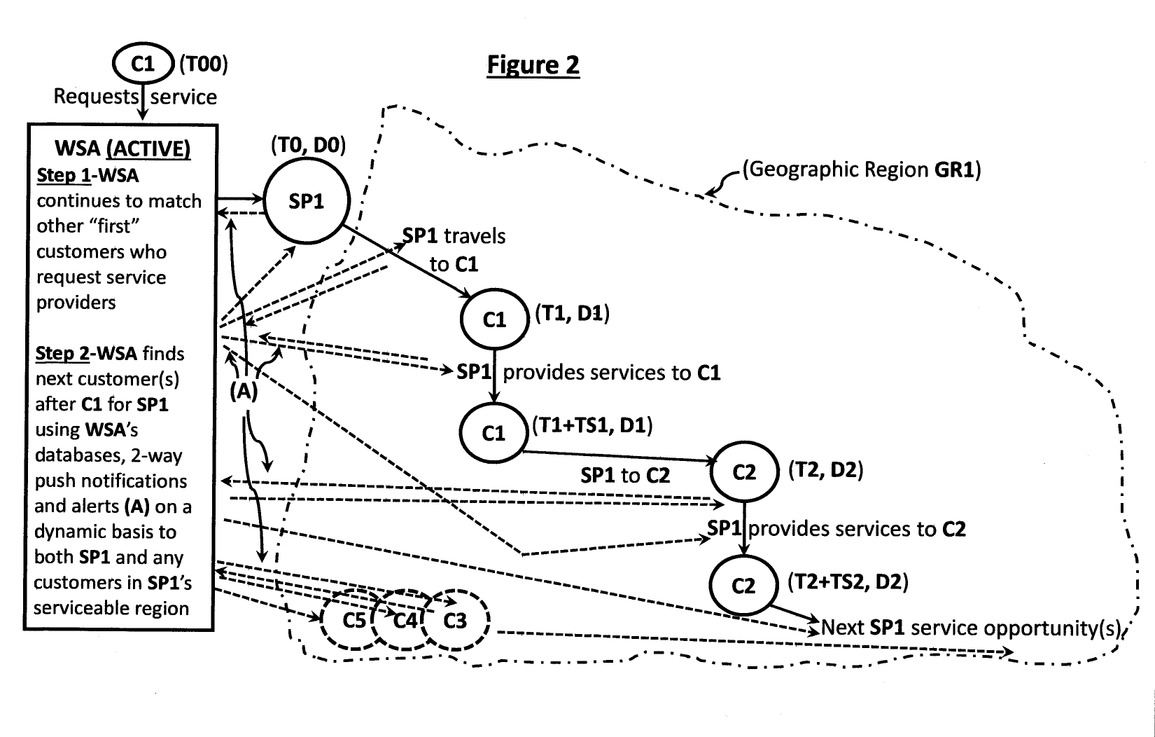

FIG. 2 illustrates a solution to the specific problem defined in FIG. 1 where WSA takes a more active role in optimizing opportunities for SP1, while also continuing to maximize opportunities for WSA and other customers in the area.

Since WSA is a computer system that can process numerous customer requests rapidly, it continues to operate as a matchmaker for a wide variety of customer requests from various customer locations that come in for various service providers to provide services at those customer locations (Step 1 in FIG. 2). In other words, just as WSA found a “first match” (customer C1 and service provider SP1), it continues to find other “first match” customer-service provider pairs and dispatches these service providers to provide services at these customer locations.

However, instead of “forgetting” about SP1 after SP1 has performed services for C1, WSA also proactively searches for additional customer opportunities for SP1 (Step 2 of FIG. 2). This is accomplished through a proactive 2-way push communication system involving emails, texts and other alerts “(A)” depicted in FIG. 2. These push communications by WSA in Step 2 are not only done with SP1, but also with other customers in SP1's serviceable region that could potentially be serviced by SP1 after SP1 finishes the C1 service. Technically, this capture of the “next customer” C2 (and follow on customers C3, C4 . . . ) for SP1 can be accomplished by following one or more of Steps (A) through (E) outlined below (but note that it is not necessary to do these steps in the specific order below):

STEP (A): WSA seeks and gets information on how long SP1 will need to service C1; this information can be obtained through the push communication system in a number of ways:

C1 may specify the time of service (e.g., a 1 hr massage) when it sends the request to WSA or WSA may request C1 to estimate the time required (or that C1 has available).

Alternatively, for routine services (e.g., air-conditioner maintenance or a car wash), the average time for completion is reasonably estimated or known (AT). In this case SP1 lets WSA know as soon as the service is requested and SP1 has accepted; or WSA already knows when C1 places request with WS because C1 clearly articulated its needs.

In other cases, the time required for a specific service is “customized” and can only be estimated after visiting and discussing with the customer at the site where the service is performed (CS1)—in this case SP1 sends an alert to WSA when SP1 has understood and estimated the task to be performed after arriving at C1's site.

Or in some cases, the time to completion cannot be estimated until the project is over—in this case, SP1 sends the alert to WSA after the task at C1 is complete.

STEP (B): WSA seeks and gets information on SP1's time and availability to perform services after the service to C1 is completed (the time availability window AW1). This can be accomplished in a variety of ways. In one method of implementation, it can be provided by SP1 to WSA via a push communication before or within a reasonable time after the service to C1 is completed, though it is preferable that WSA gets this information as early as possible, since that would give WSA more time to find the next customer(s) for SP1. Alternatively, SP1 (and any other registered SPs on WSA's network who have opted in for WSA having dynamic calendar access as part of the SP's registration process with WSA) can allow WSA dynamic access to SP1's regularly updated calendar on a real-time basis so that WSA can, without contacting SP1, automatically review the calendar and place a hold in the calendar while searching for the customer, confirming the hold when the next customer accepts;

STEP (C): WSA seeks and gets information on SP1's preferred geographic region GR1 where SP1 would ideally like to find the next customer after C1. GR1 could, in one embodiment, be an area that is within a reasonable geographic proximity to customer C1, based on driving distances, traffic conditions, weather and the like. In another embodiment, for example in situations where the service to C1 was, say, in the early afternoon and SP1 would prefer to get the last appointment of the day on SP1's way back home, GR1 would be the general region that is within a reasonable proximity to a reasonable route that is followed by SP1 on his way back to SP1's home from C1's location;

STEP (D) WSA uses its internal database of customer registries to identify potential customers in the region GR1 who may be serviceable by SP1;

STEP (E) WSA sends a push notification (email or text or other alert) to the potential customers identified in (D) above, checking to see if they want to take advantage of the services of SP1 while SP1 is in this customer area during the availability window AW1. To induce a customer to accept the offer on an impulse basis, WSA may also offer discounts or other rewards/points to them.

To make sure that there is sufficient time for SP1 to travel to the next customer C2 and complete the service that C2 requires, these prospective customers must accept WSA's offer within a calculable time period, “X1” that is determined after SP1 has informed WSA of (a) the estimated time at which SP1 will have finished servicing C1 and (2) the estimated availability window AW1 that SP1 would have after servicing C1.

X1 is estimated based on the situation. For example, if C1's service is a routine service being provided after SP1 arrives at C1's site at time T1, then X1=T1+AT, where AT is the average time required for the routine service, and this can be estimated by WSA without any input from C1 or SP1 (though C1 or SP1 may also provide this information, when C1 requests service or SP1 accepts the offer to provide service). If it is a custom service known only at arrival at the C1 site, then X1=CS1, and this information must be provided by SP1 to WSA. However, if the time for completion can only be realistically determined when a project over, then X1 may be set by WSA only after SP1 notifies WSA that service to C1 is complete. This may be either a standard reasonable time (e.g., a 15 or 30 minute break or wait by SP1 after the service to C1 is completed for WSA to find another customer who will be interested in the opportunity to be provided services by SP1), or by SP1 providing the amount of time he is willing to wait (if at all). In all these examples, to ensure reasonably that there is sufficient time for SP1 to service C1, the following must hold: X1+T2A+T2S≦AW1 (i.e., the sum of (a) the time to find the next customer C2, (b) the estimated time to travel from C1's location to a next customer's location when this next customer C2 has not yet been identified, and (c) the estimated time to service C2, when C2 has not yet been identified—must collectively be within SP1's window of availability). T2A and T2S has already been defined/described above.

To induce the next customer(s) to accept and take advantage of SP1's presence in the GR1 area, discounts may also be offered during this step. Alternatively, discounts are not offered in initial message sent to potential customers in GR1 but, if no response is received from any new customer within say, a time X1/2, discounts are offered in a second alert to customers (or if a discount has been sent initially, then additional discounts may be offered).

If a second customer C2 in GR1 expresses interest, and SP1 accepts the engagement then steps (A) through (E) above can be repeated.

If more than one customer is interested in service after C1, and C2 has already been matched with SP1, then C3 through Cn may be offered other service providers SP2, SP3 . . . etc. depending on their availability, or these additional customers may be willing to wait until SP1 has finished servicing C2.

If more than one customer is interested, it may also be possible for WSA (and SP1) to wait until the X1 time window is near closed before select the best “next customer” offer (in terms of the highest revenue to SP1) without necessarily selecting the first additional customer in C1's vicinity that has expressed interest in SP1's availability. For example, in beauty management services, if C2 is interested in a haircut but C3 is interested in a more lucrative styling/blowout, and both have responded before the X1 time window closed, C3 should be selected next.

Further, as indicated earlier, there is no need to restrict “second-customer” opportunities to just those that arise within GR1 after C1 service is complete. It is also possible to include opportunities that span a region that covers the general area between SP1's commute back from C1 (or C2 or C3 . . . ) to SP1's office (salon), as long as SP1 has additional availability.

A point or loyalty reward system can also be used within the steps above to increase the likelihood that customers and service providers are provided additional incentives to cooperate.

As the WSA system illustrated by the schematic of FIG. 2 described above operates, there will be numerous “first” customers Cls who are matched with numerous “first” service providers SP1s, and there may be a large numbers of both “Step 1” and “Step 2” operations that need to be managed by the WSA system. Step 1 and Step 2 may be conducted either sequentially or in parallel depending on the computing load on the WSA system, the available computing resources, and the appropriate business priorities. For a WSA system that matches a large number of customers and service providers in a large metropolitan area, there may already be more than one computer or processor available so that Step 1 and Step 2 may be conducted in parallel. Alternatively, a priority system may be assigned. For instance, WSA may select a “first customer” (i.e., Step 1) to always be the higher priority since the customer is the “paying” end-user, so that if a Step 1 and Step 2 request both come in simultaneously, then Step 1 is always completed first. Alternatively, WSA may offer the service of Step 2 to participating service providers for an additional fee or commission, in which case WSA may prioritize Step 2 over Step 1.

Customer conflicts can also arise between Step 1 and Step 2. For example, when WSA is looking for the next customer C2 in neighborhood GR1 while SP1 is servicing C1 in GR1 (the new Step 2 process), there is also a likelihood that C2 may independently contact WSA with a service provider request (the traditional Step 1 process). So should C2 be directed to SP1 or should C2 be matched with a different service provider SP2? In a simple embodiment of this invention to resolve such conflicts, if C2 contacts WSA before WSA contacted C2 to offer SP1's services, then C2 is always matched with a service provider other than SP1 and C2 is also removed from the list of “next customers” that SP1 could potentially service in GR1 after SP1 finishes servicing C1. In a more complex embodiment of this invention, the availability of SP1 is evaluated with respect to the actual time when C2 requires services. So, for instance, if C2 contacts WSA before WSA has started looking for the second customer for SP1 but C2's preferred time for the service could potentially fit within SP1's availability window AW1 (if already known by WSA), then C2 is automatically matched with SP1; for all other situations C2 is matched with a new service provider SP2.

It is also expressly noted that it is not necessary to perform all the steps (A) through (G) in the order illustrated above to develop a working and useful WSA system that maximizes opportunities for WSA, the customer and the service provider. Sometimes, not even all of these steps listed above may be needed. To illustrate this point, a more simplified system is described next.

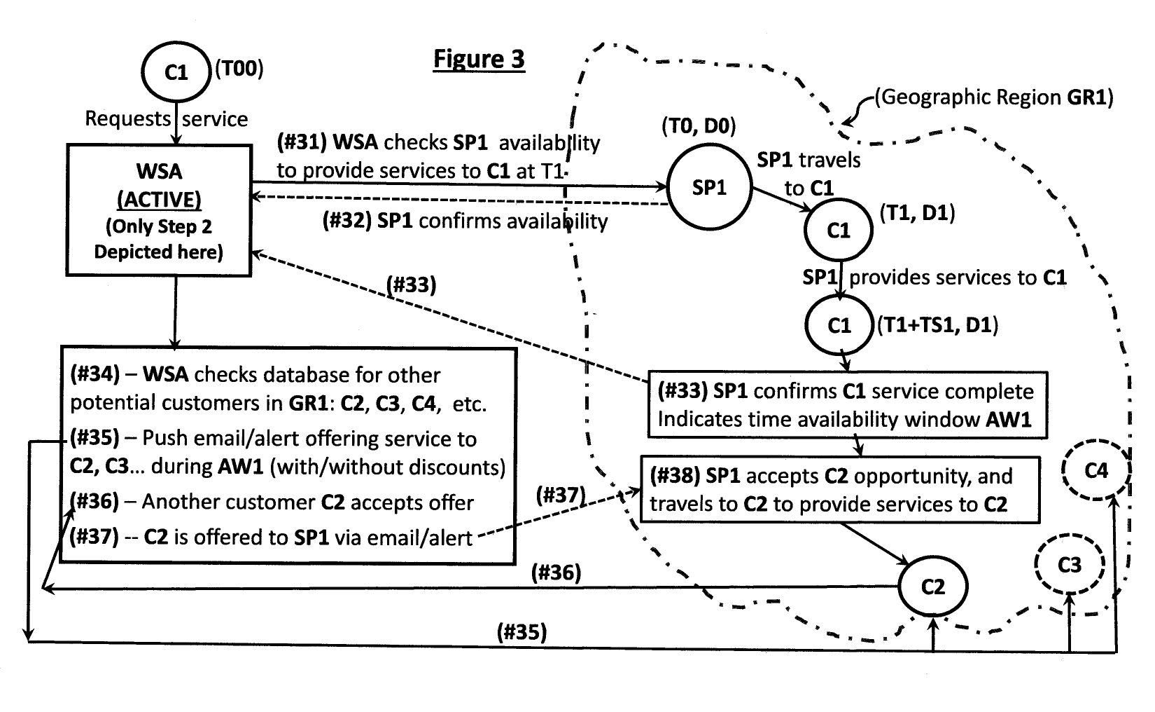

FIG. 3 shows a more simplified embodiment of the invention (and for simplicity only depicts Step 2). A first customer C1 requests a professional service to WSA. WSA contacts SP1 [#31] to check availability of a first service provider SP1, located at D0. SP1 confirms its availability to WSA and then proceeds to travel to C1's location, D1, and finishes providing the service at time T1+TS1. If SP1 has additional time available AW1 to service another customer in the vicinity of C1 (i.e., in geographic region GR1), then SP1 informs WSA via an alert/email/text. WSA then checks its database and identifies other potential customers (C2, C3, C4, etc.) in the region, contacts them via push notifications, with or without rewards, discounts or other incentives. The next customer that accepts the offer, C2, within a time X1 is offered to SP1 so long as there is sufficient time to travel to C2 and service C2. i.e., X1+TS2+(D2-D1)≦AW1. This process can be repeated again after service to C2 is completed, based on SP1's continuing availability.

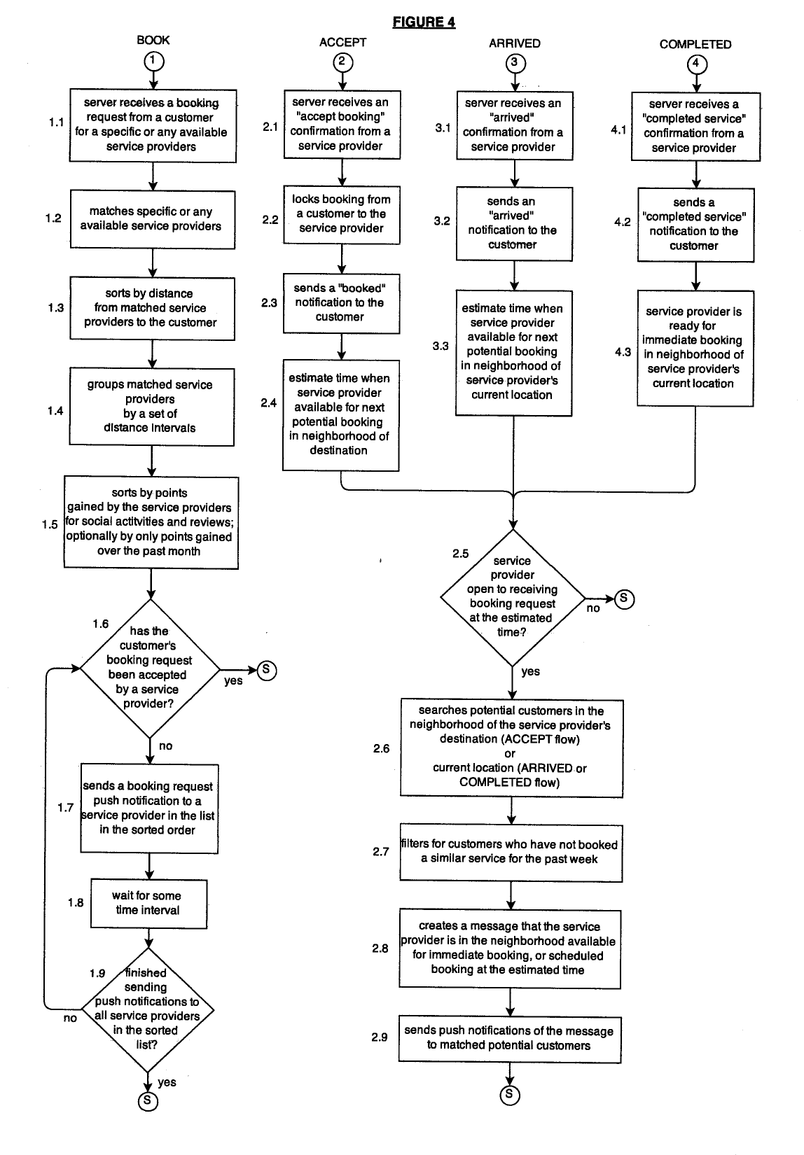

Now a complete reservation system architecture for a WSA that processes any and all customer requests while also including some of the methods discussed above to proactively maximize customer opportunities service providers is described. This illustrative embodiment involves a server-side application at the WSA (“Server App” shown in FIG. 4) that interfaces with two client-side applications (neither shown here). One of the client side applications is downloaded as an app as part of the registration process for each end user (“Customer App”), and the other is downloaded by each registered service provider (“Service Provider App”).

FIG. 4 shows four executable tasks (or instruction threads) that the WSA server(s) can process at any time that run from top to bottom, based on the type of information that comes in for the Server App to process. The information coming in to the server is classified into 4 types: (1) (BOOK) as a booking request from a customer sent by the Customer App; (2) (ACCEPT) an acceptance of the booking from a service provider sent by the Service Provider App; (3) (ARRIVED) an alert from the service provider (sent by the Service Provider App) indicating arrival at the customer location; and (4) (COMPLETED) an alert from the service provider (sent by the Service Provider App) indicating completion of service at a customer location. When a booking request comes in as an executable task at (1) (BOOK) to the server from a user, then logical flow of instructions depicted by 1.1, 1.2, 1.3, 1.4, 1.5 and 1.6 is executed in sequence. If the answer from the logical operator 1.6 is yes, then execution stops (depicted as an “S” within a circle). However, if the answer from logical operator 1.6 is “no”, then execution continues through 1.7, 1.8, and 1.9 before it reaches another stop S. Likewise, when executable task (2) (ACCEPT) comes in to the server, it executes steps 2.1 through 2.5 and stops, or continues to 2.9 and stops execution. Executable task (3) (“ARRIVED”) goes through steps 3.1, 3.2, 3.3, 2.5 and stops (if the logical response is “no”), or otherwise continues through to 2.9 and stops execution. Executable task (4) (“COMPLETED”) goes through steps 4.1, 4.2, 2.5 and stops (if the logical response is “no”), or otherwise continues through to 2.9 and stops execution.

A database(s) within the server (or at another location on another network) (but not shown in this FIG. 4) that contains up-to-date information on WSA's registered customers and service providers can also be accessed/queried on demand while executing these instruction threads. Examples of the type of information in the database(s) include: when the customer (or service provider) last requested (or was provided) service, the frequency of services requested/accepted, the current status of any service provider or customer (e.g., occupied with customer C1 or booked with customer C2 for a future date/time, etc.), the cumulative loyalty/reward points earned by the service provider or customer, etc. The specifics of each executable thread—BOOK, ACCEPT, ARRIVED and COMPLETED—are detailed next.

“BOOK”: When the server gets a customer request for either a specific service provider or any available service provider (1.1) for service to be performed at a specified time (or within a time interval) at a specified location, the server searches its database of registered service providers to find matches in the neighborhood of the customer location (1.2) who are available to provide service. Two filters are then applied to prioritize the sequence in which service providers are given this specific customer opportunity. In the first filter, the sorting is by distance from the matched service providers to the customer (1.3), which are then grouped by a set of distance intervals (1.4). Then a second filter (1.5) is applied to reward service provider loyalty, further sorting the output of 1.5 by reward points earned by the service provider to date (e.g., points gained by the service providers for social activities and reviews, or optionally only by points gained over the past month to promote frequency of use). The output of 1.5 is a prioritized list of service providers that should be offered the customer opportunity. Note that if the request in 1.1 is for a specific service provider, then that specific service provider is automatically given the highest priority by default, trumping the prioritized list of service providers calculated in 1.5.

At this point in time, the server then queries the database on whether the customer's booking request has already been accepted by a service provider (1.6). If the customer's booking request has been accepted by a service provider, then execution ends. Otherwise, the server sends the customer's booking request push notification to the first priority service provider in the sorted list of service providers. The server then waits for some time interval (determined in accordance with any reasonable business rule or an arbitrarily selected interval which can range from, say, 10 seconds to 15 minutes or longer depending on the general availability and type of service) before sending a booking request push notification to the next service provider in the sorted list of service providers, and so on. If at any time, the customer's booking request has been accepted by a service provider, the server stops sending further push notifications of the customer's booking request push notifications.

“ACCEPT”: When a service provider receives a booking request push notification from a customer (sent via the Customer App), the service provider may accept the booking request, and then this thread also works to find other opportunities for this service provider, so long as there is sufficient information available to make this determination (what information is needed and whether it is sufficient has already been discussed in the context of Step E discussed earlier). If the service provider accepts the booking request, then server checks the database to see if the booking request has been already been accepted by another service provider. If so, the service provider is notified that another service provider has already accepted the booking request. Otherwise, the server locks the booking by the customer to the service provider (2.2). The server sends a booked push notification to the customer (2.3). At this point in time, if the server has sufficient information, the server can estimate the time that the service provider will be available for the next potential booking in the neighborhood of the customer, or equivalently, the neighborhood of the service provider's destination (2.4). If the service provider is not available for further booking in the estimated time or if there is insufficient information to estimate the time (2.5), then the flow ends. Otherwise, the server searches for potential customers in the neighborhood of the service provider's destination (2.6), filters for customers who have not booked a similar service for the past week (2.7), creates a message that the service provider is in the neighborhood available for a scheduled booking at the estimated time (2.8), and broadcasts the message via push notifications to the entire list of potential customers in the neighborhood of the service provider (2.9). As a further illustration of 2.9, when “the available for booking” push notification sent to potential customers (filtered by neighborhood, by those who have not booked a similar service for, say, the past week, or by any other rule) contains the message “<specific service provider, e.g., Alice> is in <your neighborhood> available for <immediate booking or estimated time>”. The “available for booking” push notification also contains a payload of parameters (e.g., userID, sound filename, etc.). The parameter userID will be the userID of the service provider. This push notification payload is a standard Apple iOS/Android operating system specification for push notifications. At this point this execution thread on the server stops. On the Customer App side (not shown in FIG. 4), the first customer who receives the alert 2.9 from the Server App and accepts the offer books the service provider.

“ARRIVED”: When a service provider arrives at the destination where the customer is located, the service provider sends an “arrived” confirmation to the server through the WSA app (3.1). When the server receives an “arrived” confirmation, the server sends an “arrived” notification to the customer (3.2). At this point in time, if the server has sufficient information, the server can estimate the time that the service provider will be available for the next potential booking in the neighborhood of the service provider's current location (3.3). The rest of the steps in this thread are similar to the steps in the “ACCEPT” thread.

“COMPLETED”: When a service provider has completed the service at the destination where the customer is located, the service provider will send a “completed service” confirmation to the server (4.1). When the server receives a “completed service” confirmation, the server sends a “completed service” notification to the customer (4.2). The rest of the steps in this thread are similar to the steps in the “ARRIVED” thread.

It is important to emphasize again that the FIG. 4 implementation described above is a general working solution that applies to all registered service providers and customers at the same time. So, in principle, when a customer requests a service provider and a service provider accepts and becomes “SP1” in the context of FIGS. 1 to 3 described earlier, other service providers SP2, SP3 can be automatically processed in the 4 threads. Thus, when SP1 moves on to the “ACCEPT” (and later “ARRIVED” and “COMPLETED”) logic flows, new opportunities are being identified for SP1—but at the same time another customer may be booked in the BOOK logic flow and may move on to the ACCEPT flow. In other words, there is no need to differentiate between an SP1 and an SP2 in this general implementation. Priority is also based on first come first served for both customers and service providers.

While the invention has been described above or illustrated in figures in conjunction with specific embodiments, it is evident that many alternatives, modifications, permutations and variations will become apparent to those skilled in the art in light of the foregoing description. Accordingly, it is intended that the present invention embraces all such alternatives, modifications and variations as fall within the scope of the claims below.

What is claimed is:

1. In a computer program product for an on-demand matchmaking service that already incorporates a first method to communicate via a network and reactively facilitate transactions between registered service providers and registered users in a geographic region based on user demand and service provider availability, the additional use of a second method to improve the utilization of at least a first service provider with whom a first user transaction has already been facilitated by said first method, wherein said second method proactively facilitates the next transaction between said first service provider and a second user.

2. The computer program product of claim 1 wherein said first method and said second method are conducted in parallel using parallel processors;

3. The computer program product of claim 1 implemented on one processor wherein, if there is a simultaneous request for computing resource from said first method and said second method, the first method is always executed first.

4. The computer program product of claim 1 implemented on one processor wherein, if there is a simultaneous request for computing resource from said first method and said second method, the second method is always executed first.

5. The computer program product of claim 1 above, that is provided in a form that is downloadable on a mobile device.

6. The second method of claim 1, wherein the second user and first user are geographically proximate.

7. The second method of claim 1 further comprising:
a method to find the time availability window of said first service provider to provide additional services after completion of service to the first user;
communicating to a group of users that do not include the first user, to ascertain interest from any user in said group of users to receive services from said first service provider within said time availability window;
receiving a response back from a user in said group of users that confirms interest in receiving services from said first service provider user within said time availability window;
facilitating said next transaction between said first service provider and said responding user;

8. The method of claim 7, wherein said next transaction is facilitated between the first service provider and the first responding user from said group of users.

9. The method of claim 7 wherein there is more than one responding user from said group of users, and said next transaction is facilitated between the first service provider and the responding user from said group of users that is the most proximate to the first user.

10. The method of claim 7 wherein there is more than one responding user from said group of users, and said next transaction is facilitated between the first service provider and the responding user from said group of users that provides the highest revenue opportunity to the first service provider.

11. The method to find time availability in claim 7, wherein the time availability window is received via a communication from the first service provider after completing services to the first user.

12. The method to find time availability in claim 7, wherein said time availability window is provided via a communication from the first service provider a time proximate to when that first transaction was completed.

13. The method to find time availability in claim 7, wherein the time availability window is received via a communication from the first service provider between the time that first transaction is completed and within 30 minutes of first service provider completing service to the first user.

14. The method to find time availability in claim 7, wherein said time availability window is calculated by directly accessing a time-synchronized calendar of the first service provider.

15. The method of claim 7 wherein said group of users are selected from a geographic region that is also specified by the first service provider.

16. An on-demand service reservation management method implemented as a computer program on at least one computer server in a communications network, where said server can communicate with other computing devices in the network that are owned by a plurality of registered customers and a plurality of registered service providers, said server also having access to at least one database that maintains information on at least (a) the last known location of each customer and each service provider, and (b) current availability status of each service provider, wherein said method comprises:
receiving a first service request from a first customer for a service to be provided within a first time interval at a first location;
accessing said database and matching said first request with service providers who are available to perform said first service within said first interval at said first location, thereby creating a list of available service providers;
creating a prioritized list of said available service providers based on the shortest distance between said first location and the location of each of said available service providers;
sending a series of communications, each with a pre-defined time limit for acceptance, offering said first request to each available service provider in the sequence of said prioritized list;
receiving a notification from a first available service provider accepting said offer;
calculating an approximate time when said first available service provider will complete service at said first location and be available to provide services to a customer other than said first customer within a specified distance from said first location;
accessing said database and matching customers, other than first customer, who are located within said specified distance, to create a list of nearby customers;
sending a communication to all said nearby customers offering service by said first available service provider at a second time interval;
receiving a first acceptance from a first nearby customer; and
reserving said first acceptance with said first available service provider.

17. The method of claim 16 where said calculation is estimated by adding (x) an average time for completion of the service requested to (y) the average time it would take to travel to said specified distance by automobile.

18. The method of claim 16 where said specified distance is less than 5 miles.

19. The method of claim 18 where said priority list is further filtered to only include service providers with a pre-defined minimum number of loyalty reward points.

20. An on-demand service reservation management method implemented as a computer program on at least one computer server in a communications network, where said server can communicate with other computing devices in the network that are owned by a plurality of registered customers and a plurality of registered service providers, said server also having access to at least one database that maintains information on at least (a) the last known location of each customer and each service provider, and (b) current availability status of each service provider, wherein said method comprises:
receiving a first service request from a first customer for a service to be provided within a first time interval at a first location;
accessing said database and matching said first request with service providers who are available to perform said first service within said first interval at said first location, thereby creating a list of available service providers;
creating a prioritized list of said available service providers based on the shortest distance between said first location and the location of each of said available service providers;
sending a series of communications, each with a pre-defined time limit for acceptance, offering said first request to each available service provider in the sequence of said prioritized list;
receiving a notification from a first available service provider accepting said offer;
receiving a notification from said first available service provider that service has been completed at said first location;
accessing said database and matching customers, other than first customer, who are located within said specified distance, to create a list of nearby customers;
sending a communication to all said nearby customers offering service by said first available service provider immediately and up to a specified second time;
receiving a first acceptance from a first nearby customer; and
reserving said first acceptance with said first available service provider.
